(19) United States
(12) Patent Application Publication
(10) Pub. No.: US 2026/0329601 A1
(43) Pub. Date: Oct. 22, 2026

(54) ELECTRONIC DEVICE AND METHOD FOR EXECUTING, STORING, AND DISPLAYING APPLICATION

(71) Applicant: SAMSUNG ELECTRONICS CO., LTD., Suwon-si (KR)

(72) Inventors: Haebahrem Ahram SUH, Suwon-si (KR); Jungmi KIM, Suwon-si (KR); Jinwan AN, Suwon-si (KR); Jinkyo CHUNG, Suwon-si (KR); Heeyoung CHUNG, Suwon-si (KR)

(21) Appl. No.: 19/462,624

(22) Filed: Jan. 28, 2026

Related U.S. Application Data
(63) Continuation of application No. PCT/KR2024/005858, filed on Apr. 30, 2024.

(30) Foreign Application Priority Data
Aug. 29, 2023 (KR) 10-2023-0113556
Oct. 27, 2023 (KR) 10-2023-0145694

(51) Int. Cl. G06F 9/451

(52) U.S. Cl. CPC G06F 9/451

(57) ABSTRACT

An electronic device and a method for executing, storing, and displaying an application are provided. This method for displaying a recently executed application comprises an operation of receiving a user input for displaying at least one recently executed application. The method comprises an operation of displaying information on an application including the at least one recently executed application on the basis of the user input. Information on an application including at least one application comprises a main area which indicates a first application among the at least one application, and a task area which indicates information on at least one task executed in the first application.

### CROSS-REFERENCE TO RELATED APPLICATIONS

This application is a continuation application, claiming priority under §365(c), of International Application No. PCT/KR2024/005858 filed on Apr. 30, 2024, which is based on and claims the benefit of Korean patent application number 10-2023-0145694 filed on Oct. 27, 2023, in the Korean Intellectual Property Office and of Korean patent application number 10-2023-0113556 filed on Aug. 29, 2023, in the Korean Intellectual Property Office, the disclosures of which are incorporated by reference herein in their entireties.

### BACKGROUND

### 1 Field

The embodiments of the present document relate to an electronic device and a method for executing, storing, and displaying an application.

### 2 Description of the Related Art

A user may be provided with various applications from an online store or an application provider, and may install the applications in a personal terminal device. The user may execute numerous applications installed in the terminal device as needed. The terminal device may provide an application list together with simple information so that the user may conveniently re-execute the applications that the user has executed.

The information described above may be provided as the related art for the purpose of enhancing the understanding of the present disclosure. No assertion or determination is made with respect to the applicability of any of the above-mentioned as the prior art related to the present disclosure.

### SUMMARY

A method of executing an application and storing the executed application according to various embodiments of the present document may execute an application based on a first input of a user, and display the executed application on a display. The method of executing and storing the application may execute a first task of the application based on a second input of the user while the application is being executed, and display the executed first task on the display. The method of executing and storing the application may store information on the executed application and the executed first task in a designated area of a memory.

A method of displaying a recently executed application according to various embodiments of the present document may receive a user input for displaying at least one recently executed application. The method of displaying the application may display information on an application including the at least one recently executed application based on the user input. The information on the displayed application may include a main area indicating a first application among the at least one application and a task area indicating information on at least one task executed in the first application.

An electronic device according to various embodiments of the present document may include a display, a memory storing instructions to be executed, and at least one processor accessing the memory and executing the instructions. The at least one processor may identify at least one recently executed application when receiving an input for displaying the at least one recently executed application. The at least one processor may identify at least one task executed in the identified at least one application. The at least one processor may display a first application among the identified at least one application in a main area of the display, and display information on at least one task executed in the first application in a task area of the display.

A non-transitory computer-readable storage medium on which a program for performing the method of executing an application and storing the executed application according to various embodiments of the present document is recorded may perform an operation of executing an application based on a first input of a user, and displaying the executed application on a display. The storage medium may perform an operation of executing a first task of the application based on a second input of the user while the application is being executed, and displaying the executed first task on the display. The storage medium may perform an operation of storing information on the executed application and the executed first task in a designated area of a memory.

### BRIEF DESCRIPTION OF THE DRAWINGS

FIG. 1 is a block diagram of an electronic device in a network environment according to various embodiments.

FIG. 2 is a block diagram illustrating a configuration of an electronic device according to various embodiments.

FIG. 3 is a diagram illustrating a screen in which a recently executed application is displayed according to various embodiments.

FIGS. 4A, 4B, 4C, and 4D are diagrams illustrating a file-associated task downloaded in a search application according to various embodiments.

FIGS. 5A, 5B, 5C, and 5D are diagrams illustrating a task associated with a messenger application according to various embodiments.

FIGS. 6A and 6B are diagrams illustrating an operation of a file-associated task according to various embodiments.

FIG. 7 is a flowchart illustrating an operation of a file-associated task according to various embodiments.

FIG. 8 is a diagram illustrating a notification message associated with a file-associated task according to various embodiments.

FIGS. 9A and 9B are diagrams illustrating a search task according to various embodiments.

FIGS. 10A and 10B are diagrams illustrating a temporary storing task according to various embodiments.

FIGS. 11A and 11B are diagrams illustrating a temporary storing task according to various embodiments.

FIGS. 12A and 12B are diagrams illustrating a task associated with a measurement application according to various embodiments.

FIGS. 13A and 13B are diagrams illustrating a task associated with a control application according to various embodiments.

FIGS. 14A and 14B are diagrams illustrating a frequent-use task according to various embodiments.

FIGS. 15A, 15B, and 15C are diagrams illustrating a user registration task according to various embodiments.

FIGS. 16A and 16B are diagrams illustrating an associated task according to various embodiments.

FIG. 17 is a flowchart illustrating a method of executing an application according to various embodiments.

### DETAILED DESCRIPTION

Hereinafter, embodiments of the present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein. In connection with the description of the drawings, the similar or same reference numerals may be used for the similar or same constituent elements. In addition, in the drawings and related descriptions, the description of well-known features and configurations may be omitted for clarity and conciseness.

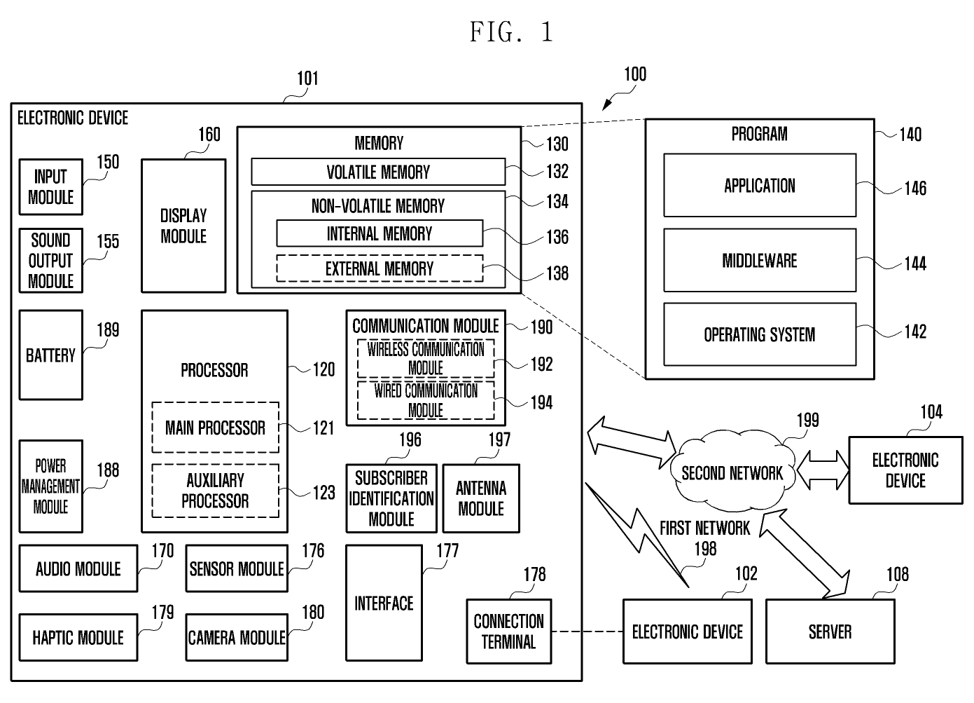

FIG. 1 is a block diagram illustrating an electronic device 101 in a network environment 100 according to various examples. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an example, the electronic device 101 may communicate with the electronic device 104 via the server 108. According to an example, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some examples, at least one of the components (e.g., the connection terminal 178) may be omitted from the electronic device 101, or one or more other components may be added in the electronic device 101. In some examples, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one example, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an example, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an example, the auxiliary processor 123 (e.g., an image signal processor or a communication processor) may be implemented as part of another component (e.g., the camera module 180 or the communication module 190) functionally related to the auxiliary processor 123. According to an example, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an example, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an example, the display module 160 may include a touch sensor adapted to detect a touch, or a pressure sensor adapted to measure the intensity of force incurred by the touch.

The audio module 170 may convert a sound into an electrical signal and vice versa. According to an example, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an example, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an example, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an example, the haptic module 179 may include, for example, a motor, a piezoelectric element, or an electric stimulator.

The camera module 180 may capture a still image or moving images. According to an example, the camera module 180 may include one or more lenses, image sensors, image signal processors, or flashes.

The power management module 188 may manage power supplied to the electronic device 101. According to one example, the power management module 188 may be implemented as at least part of, for example, a power management integrated circuit (PMIC).

The battery 189 may supply power to at least one component of the electronic device 101. According to an example, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an example, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an example, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an example, the antenna module 197 may include an antenna including a radiating element composed of a conductive material or a conductive pattern formed in or on a substrate (e.g., a printed circuit board (PCB)). According to an example, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an example, another component (e.g., a radio frequency integrated circuit (RFIC)) other than the radiating element may be additionally formed as part of the antenna module 197.

According to various examples, the antenna module 197 may form an mmWave antenna module. According to an example, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an example, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example, the external electronic device 104 may include an internet-of-things (IoT) device. The server 108 may be an intelligent server using machine learning and/or a neural network. According to an example, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various examples may be one of various types of electronic devices. The electronic devices may include, for example, a portable communication device (e.g., a smartphone), a computer device, a portable multimedia device, a portable medical device, a camera, a wearable device, or a home appliance. According to an example of the disclosure, the electronic devices are not limited to those described above.

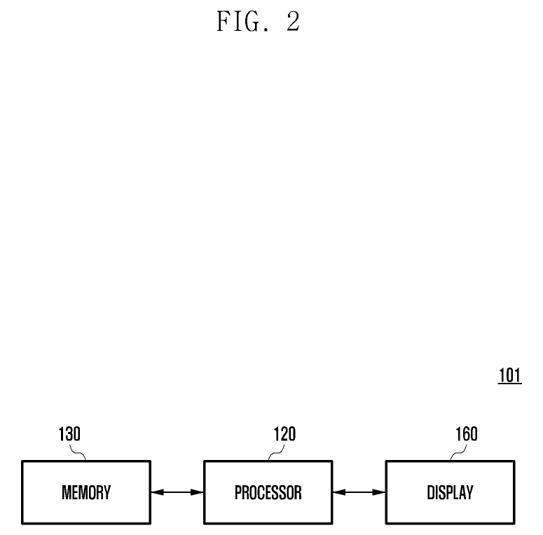

FIG. 2 is a block diagram illustrating a configuration of an electronic device according to various embodiments.

With reference to FIG. 2, the electronic device 101 may include a memory 130, a processor 120, and a display 160.

The memory 130 (e.g., the memory 130 in FIG. 1) may store instructions to be executed. The instructions to be executed may be loaded into the processor 120 (e.g., the processor 120 in FIG. 1) and may be executed. In addition, the memory 130 may store information on an application (app) and a task executed in the application. For example, the information on the task may include link information to be displayed on the display 160, a type of the task, a file name, last perform information, an image, a text, and/or a setting item. The information on the application and the task may be stored in a designated area of the memory 130, and the designated area of the memory 130 may be a storage area designated in the application.

The processor 120 may access the memory 130 to execute instructions. The processor 120 may execute the instructions to control each configuration of the electronic device 101 or perform a set operation. The electronic device 101 may include one or more processors 120.

The processor 120 may execute an application according to a user’s command, and may display the executed application on the display 160. While the application is executed, the processor 120 may perform a task of the application. For example, when the application is a messenger application, the processor 120 may perform a messenger task and/or a file-associated task. The file-associated task may include a task of downloading a file. When the application is a search application, the processor 120 may perform a search task and/or a file-associated task. When the application is an application including a memo attribute, the processor 120 may perform an edit task (e.g., writing) and/or a temporary storing task. The application including the memo attribute may mean an application including writing and document editing functions. As one example, the application including the memo attribute may include a memo application, a community application, and/or a board application. Alternatively, when the application is a measurement application (e.g., a health application) or a control application (e.g., an IoT application), the processor 120 may perform an actionable task. The processor 120 may display information on the executed application and the executed task on the display 160, and may store the information in a designated area of the memory 130. Alternatively, when the executed application is terminated while being executed, the processor 120 may store information on the executed application and the executed task in a designated area of the memory 130.

The processor 120 may display information on a recently executed application and a task according to a user’s command. The processor 120 may identify the recently executed application and may identify a task executed in the identified application. Further, the processor 120 may display the identified application and information on a task executed in the identified application on the display 160. The processor 120 may display the identified application in an area of the display 160, and may display information on the executed task in a surrounding area of the displayed application. For example, the information on the task may include link information to be displayed on the display 160, a type of the task, a file name, last perform (or last performed) information, an image, a text, and/or a setting item.

As one example, when the identified application is a messenger application, the processor 120 may display a messenger task and/or a file-associated task together with the messenger application on the display 160. When the identified application is a search application, the processor 120 may display a search task and/or a file-associated task together with the search application on the display 160. When the identified application is an application including a memo attribute, the processor 120 may display an edit task and/or a temporary storing task together with the application including the memo attribute on the display 160. Alternatively, when the identified application is a measurement application or a control application, the processor 120 may display an actionable task together with the measurement application or the control application on the display 160.

When one task is selected, the processor 120 may display the selected task on the display 160 based on link information. When the identified application is a messenger application and a messenger task is selected, the processor 120 may execute the messenger application. Further, the processor 120 may display the messenger task on the display 160 based on link information on the messenger task. As one example, the messenger task may include three messenger tasks of a messenger task for conversation with A, a messenger task for conversation with B, and a messenger task for conversation with C. When the messenger task for conversation with B among the three messenger tasks is selected, the processor 120 may execute the messenger application, and may display the messenger task for conversation with B on the display 160 based on information on the messenger task for conversation with B.

When the identified application is a messenger application and a file-associated task is selected, the processor 120 may display information on at least one file included in the file-associated task and a performance operation item on the display 160. For example, the performance operation item may include an open item, a go to item, and/or a delete item of the file. As one example, the file-associated task may include an aaa file, a bbb file, a ccc file, and a ddd file downloaded in the messenger application. In this case, when the file-associated task is selected, the processor 120 may display information on the four files and the performance operation item on the display 160. When the open item of the ccc file among the four files is selected, the processor 120 may execute an application associated with the ccc file and may display the ccc file on the display 160.

When the identified application is a search application and a search task is selected, the processor 120 may execute the search application. Further, the processor 120 may display the search task on the display 160 based on link information on the search task. As one example, the search task may include a camping search result, a travel search result, and a restaurant search result searched in the search application. In this case, when the search task is selected, the processor 120 may display information on the three search results on the display 160. When the camping search result among the three search results is selected, the processor 120 may execute the search application and may display the camping search result on the display 160.

When the identified application is a search application and a file-associated task is selected, the processor 120 may, similarly to the above, display information on at least one file included in the file-associated task and a performance operation item on the display 160. In addition, when there is a non-performed file for a preset time, the processor 120 may display a message associated with the non-performance of the file on the display 160.

When the identified application is an application including a memo attribute and a temporary storing task is selected, the processor 120 may execute the application including the memo attribute. Further, the processor 120 may display the temporary storing task on the display 160 based on link information on the temporary storing task.

Alternatively, when the identified application is a measurement application or a control application and an actionable task is selected, the processor 120 may execute the measurement application or the control application. Further, the processor 120 may display the actionable task on the display 160 based on link information on the actionable task.

The processor 120 may register an actionable task used equal to or greater than a preset number of times in the measurement application or the control application as a frequent-use task, and may display information on the frequent-use task registered together with the measurement application or the control application on the display 160. In addition, when a task registration item is selected, the processor 120 may sort and display actionable tasks associated with the measurement application or the control application based on a number of times of uses. The processor 120 may register a selected actionable task among actionable tasks displayed according to a user’s command, and may display the actionable task registered together with the measurement application or the control application on the display 160.

In addition, the processor 120 may register an associated task. For example, when a task registration item is selected, the processor 120 may register a second application successively performed with the first application input from a user as an associated task with the first application. Alternatively, the processor 120 may identify an execute routine of the second application successively performed with the first application. The processor 120 may register the identified second application as an associated task with the first application. The processor 120 may display information on the associated task registered together with the first application on the display 160.

The display 160 (e.g., the display module 160 in FIG. 1) may display an application executed under control of the processor 120 (e.g., the processor 120 in FIG. 1) and a task performed in the application. Alternatively, the display may display information on a recently executed application and a task executed in the application.

The electronic device 101 may further include an input interface (e.g., the input module 150 in FIG. 1). The processor 120 may receive from a user, through the input interface, an execute command of an application, a task execute command, a command for displaying a recently executed application, a task selection command, and/or a task registration command.

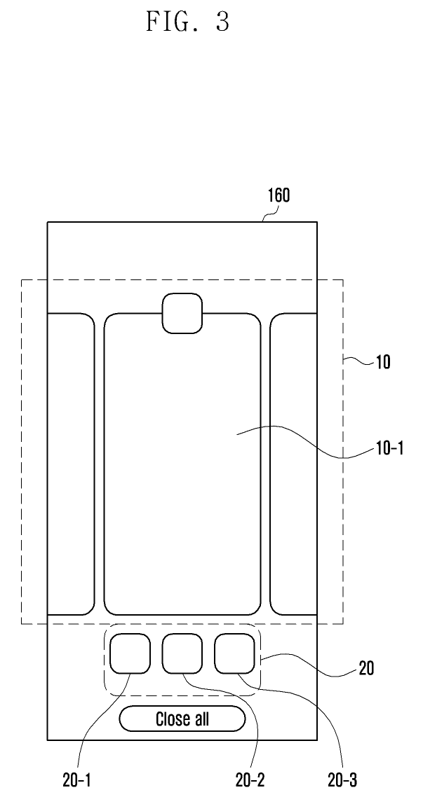

FIG. 3 is a diagram illustrating a screen in which a recently executed application is displayed according to various embodiments.

With reference to FIG. 3, the display 160 may display a recently executed application area 10 and a task area 20. For example, an application area 10 may display one main application 10-1. The application area 10 may include at least one application. Further, the main application 10-1 may be sequentially switched to another application by a touch gesture (e.g., a swipe, a flick). The task area 20 may include at least one task 20-1, 20-2, and 20-3 performed in the main application 10-1. For example, the tasks 20-1, 20-2, and 20-3 may include a file-associated task, a messenger task, a search task, a temporary storing task, an actionable task, a user registration task, and/or a frequent-use task, and a user registration task.

For example, when the main application 10-1 is a search application, and three search tasks and one file downloading task are performed in the search application, the task area 20 may include a search task including three search results and a file-associated task including one file. If the main application 10-1 is switched to a messenger application and two messenger tasks are performed in the messenger application, the task area 20 may include two messenger tasks.

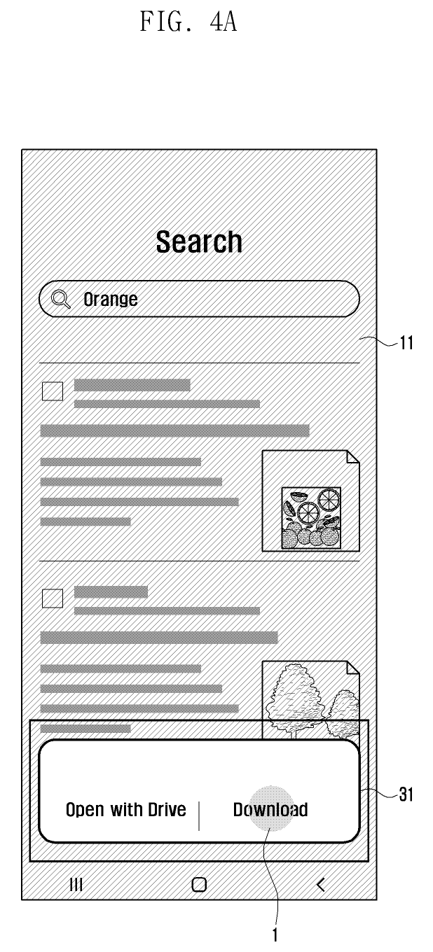

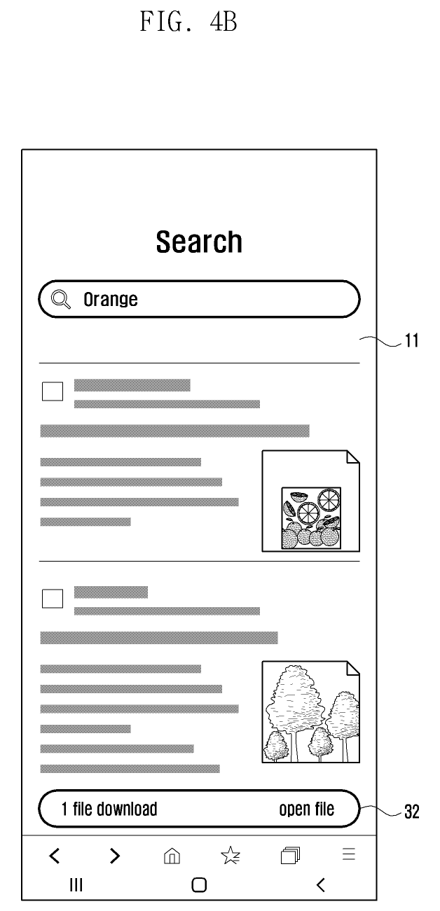

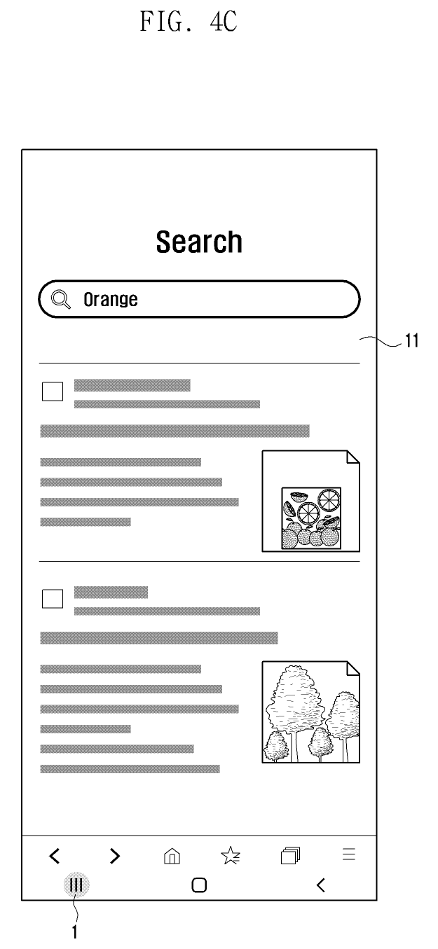

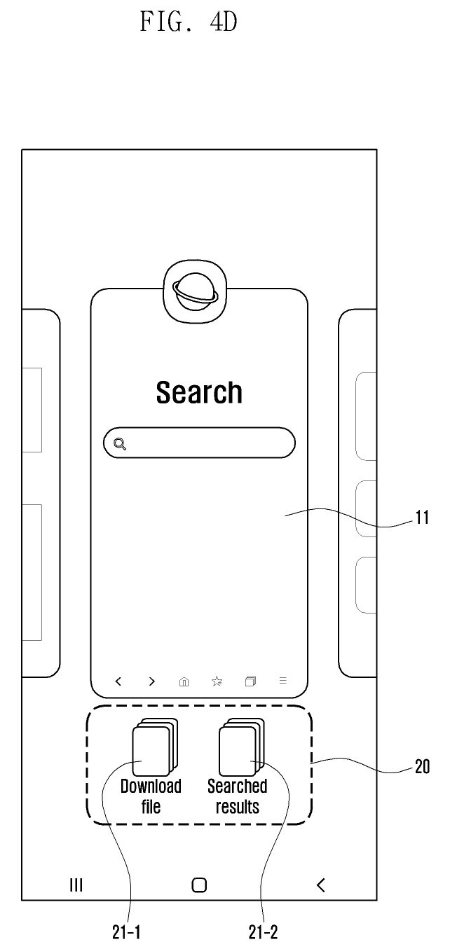

FIGS. 4A, 4B, 4C, and 4D are diagrams illustrating a file-associated task downloaded in a search application according to various embodiments.

With reference to FIG. 4A, a screen in which a search application 11 is executed is illustrated. In the search application 11, a search task and/or a file downloading task may be performed. When a file (or data) is selected in the search application 11, a task selection window 31 for selecting a task to be performed may be displayed. For example, the task selection window 31 may include a download item. When a selection of the download item is input (1), the electronic device 101 may download the selected file.

With reference to FIG. 4B, a screen of the search application 11 in which a file downloading task is performed is illustrated. When a file downloading task is completed, the electronic device 101 may display a window 32 indicating completion of the download task.

With reference to FIG. 4C, a screen in which the search application 11 is displayed is illustrated. The window 32 indicating completion of the download task may disappear after being displayed for a predetermined time. For example, the predetermined time may be set to 1 second, 3 seconds, and the like. After the file downloading task is completed, a selection of a screen switching item may be input (1). For example, the screen switching item may be an item for displaying a recently executed application.

With reference to FIG. 4D, a screen displaying a recently executed application is illustrated. When the screen of the search application 11 is switched to a screen of a recently executed application, the electronic device 101 may display an application area 10 (e.g., depicted in FIG. 4A) and a task area 20. The application area 10 may display a recently executed application including a main application. Since the search application 11 has been executed immediately before displaying the recently executed application, the search application 11 may be displayed as the main application of the application area 10. Further, since the main application is the search application 11, the task area 20 may display tasks 21-1 and 21-2 performed in the search application 11. For example, when the search application 11 is executed and a file downloading task and a search task are performed, the task area 20 may display a file-associated task 21-1 and a search task 21-2. The file-associated task 21-1 may include at least one file downloaded in the search application 11. The search task 21-2 may include at least one search result performed in the search application 11.

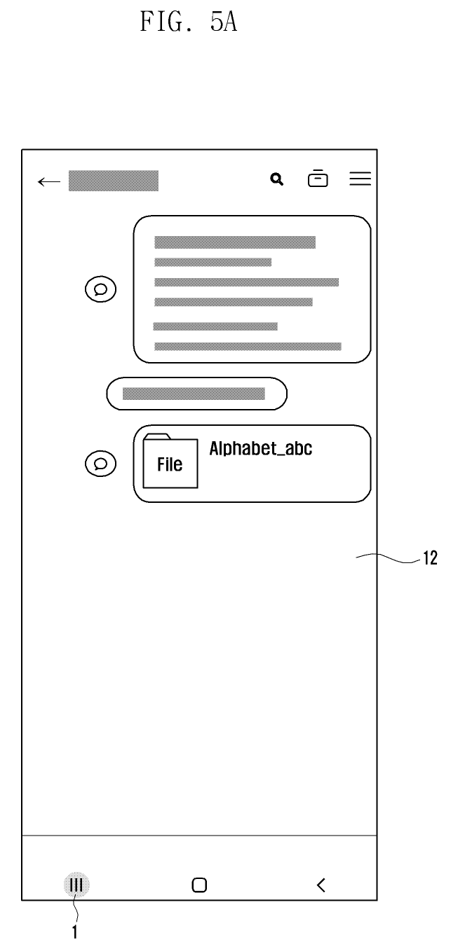

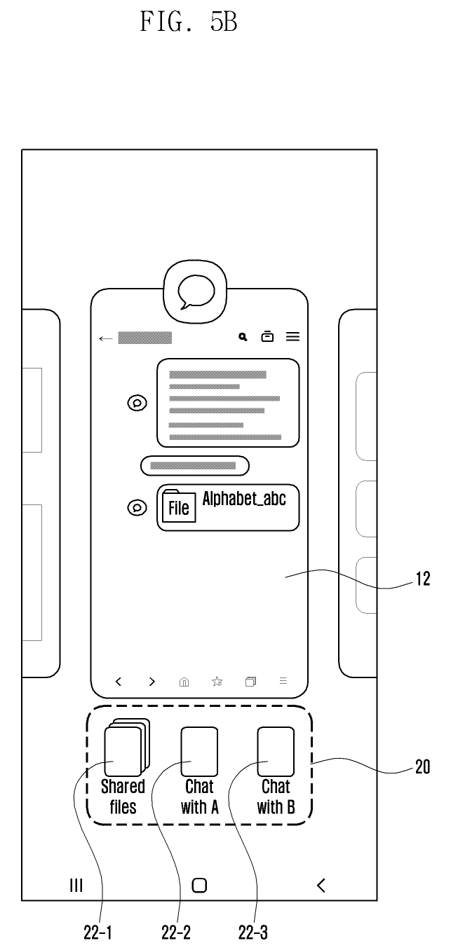

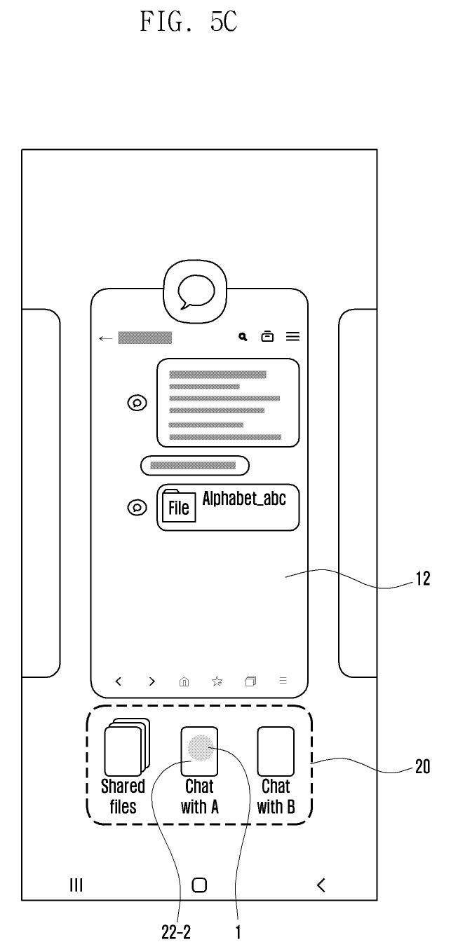

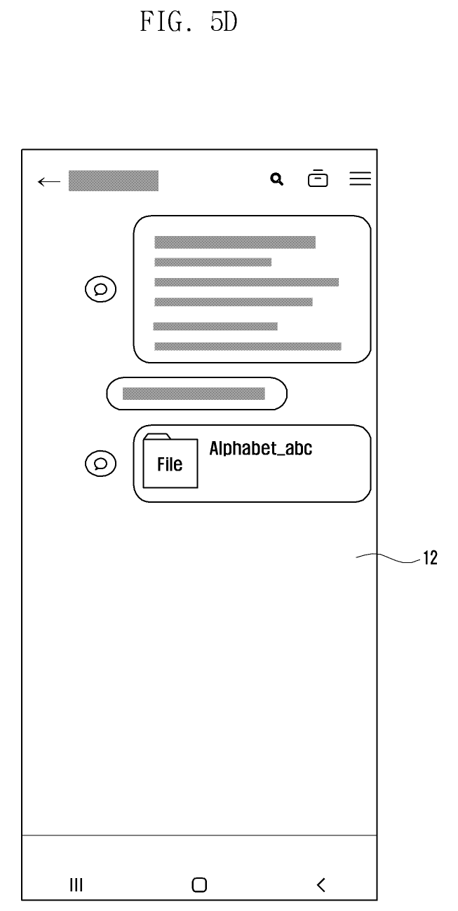

FIGS. 5A, 5B, 5C, and 5D are diagrams illustrating a task associated with a messenger application according to various embodiments.

With reference to FIG. 5A, a screen in which a messenger application 12 is executed is illustrated. In the messenger application 12, a messenger task and/or a file-associated task (e.g., file downloading) may be performed. In the messenger application 12, a participant may upload a file, and the electronic device 101 may perform a download task (or a share task) of the uploaded file according to a user’s input. In the messenger application 12, a selection of a screen switching item may be input (1). When the screen switching item is selected, the electronic device 101 may switch to a screen of a recently executed application.

With reference to FIG. 5B, a screen displaying a recently executed application is illustrated. When the screen of the messenger application 12 is switched to the screen of the recently executed application, the electronic device 101 may display an application area 10 (e.g., depicted in FIG. 4A) and a task area 20. The application area 10 may display a main application. Since the messenger application 12 has been executed immediately before displaying the recently executed application, the messenger application 12 may be displayed as the main application of the application area 10. Further, since the main application is the messenger application 12, the task area 20 may display tasks 22-1, 22-2, and 22-3 performed in the messenger application 12. For example, when a file downloading task and a messenger task are performed when the messenger application 12 is executed, the task area 20 may display a file-associated task 22-1 and messenger tasks 22-2 and 22-3. The file-associated task 22-1 may include one or more files downloaded in the messenger application 12. The messenger tasks 22-2 and 22-3 may include one or more messenger tasks performed in the messenger application 12.

With reference to FIG. 5C, a screen in which a selection of a messenger task 22-2 for conversation with A is received, as input (1), is illustrated. When the messenger task 22-2 for conversation with A is selected, the electronic device 101 may execute the messenger application 12, and may display the messenger task 22-2 for conversation with A on the display 160 based on information on the messenger task 22-2 for conversation with A.

With reference to FIG. 5D, a screen in which the messenger task 22-2 for conversation with A is displayed is illustrated. The electronic device 101 may display the last state of the messenger task 22-2 for conversation with A on the messenger application 12.

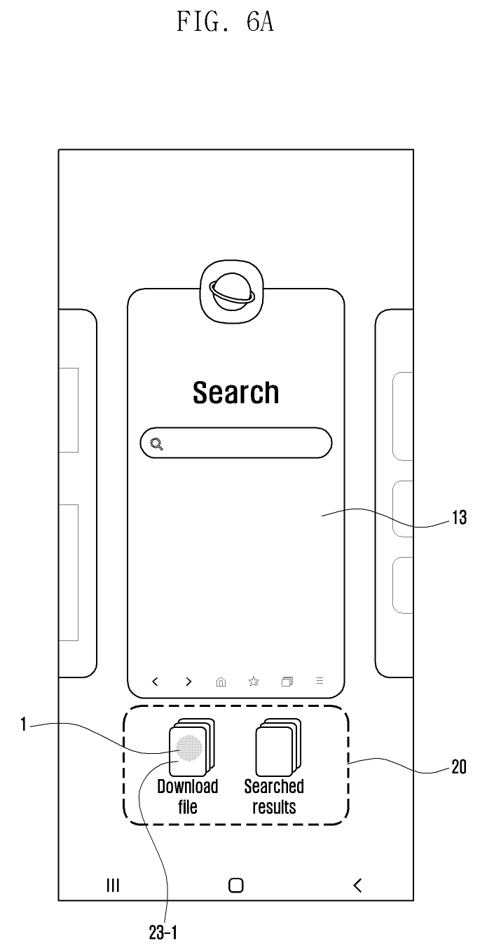

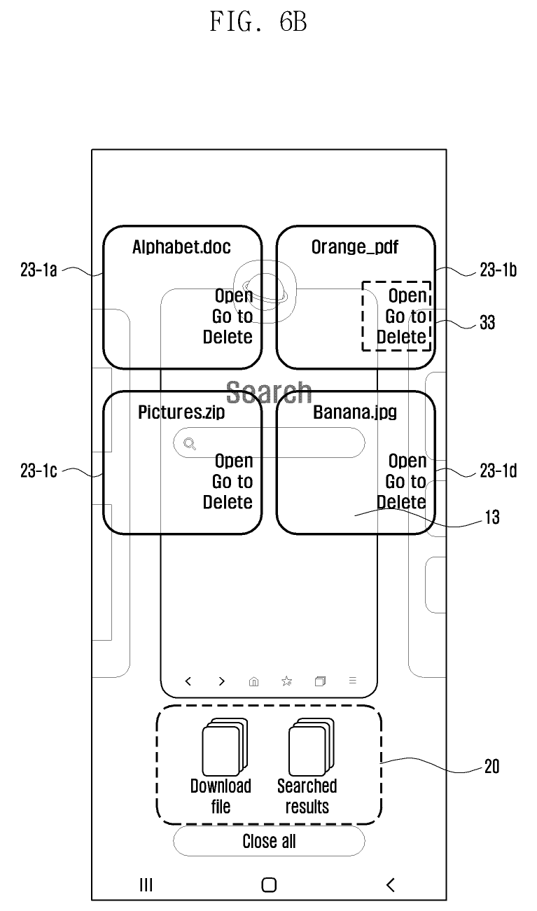

FIGS. 6A and 6B are diagrams illustrating an operation of a file-associated task according to various embodiments.

With reference to FIG. 6A, a screen displaying a recently executed application is illustrated. For example, when an application most recently executed is a search application 13, the electronic device 101 may display the search application 13 as a main application. Alternatively, the electronic device 101 may switch the main application from another application to the search application 13 by a user’s touch gesture. When a file downloading task is performed in the search application 13, the task area 20 may include a file-associated task 23-1. The file-associated task 23-1 may include a file downloaded in the search application 13. The electronic device 101 may receive, as input (1), a command to select the file-associated task 23-1.

With reference to FIG. 6B, a screen displaying information on a file included in the file-associated task 23-1 is illustrated. When the selection of the file-associated task 23-1 is input (1), the electronic device 101 may display information on the file included in the file-associated task 23-1. For example, the information on the file may be displayed as an icon, an image, and/or a text. The information on the file may be transparently displayed. Accordingly, in a background of a state in which the information on the file is displayed, the search application 13 as the main application may be viewed. Accordingly, in the state in which the information on the file is displayed, a user may easily identify an application in which the file is downloaded.

For example, when the file-associated task 23-1 includes four files, the electronic device 101 may display information on the four files 23-1a, 23-1b, 23-1c, and 23-1d, and the information on each file may include an item 33 for performing an operation associated with the file. For example, the item 33 for performing an operation associated with the file may include open, go to, and delete items. As one example, when an open item is selected in information on an orange_pdf file 23-1b, the electronic device 101 may cause the orange_pdf file 23-1b to be executed in an associated application. When a go to item is selected in information on the orange_pdf file 23-1b, the electronic device 101 may switch a screen to a location in which the orange_pdf file 23-1b is stored. When a delete item is selected in information on the orange_pdf file 23-1b, the electronic device 101 may delete the orange_pdf file 23-1b.

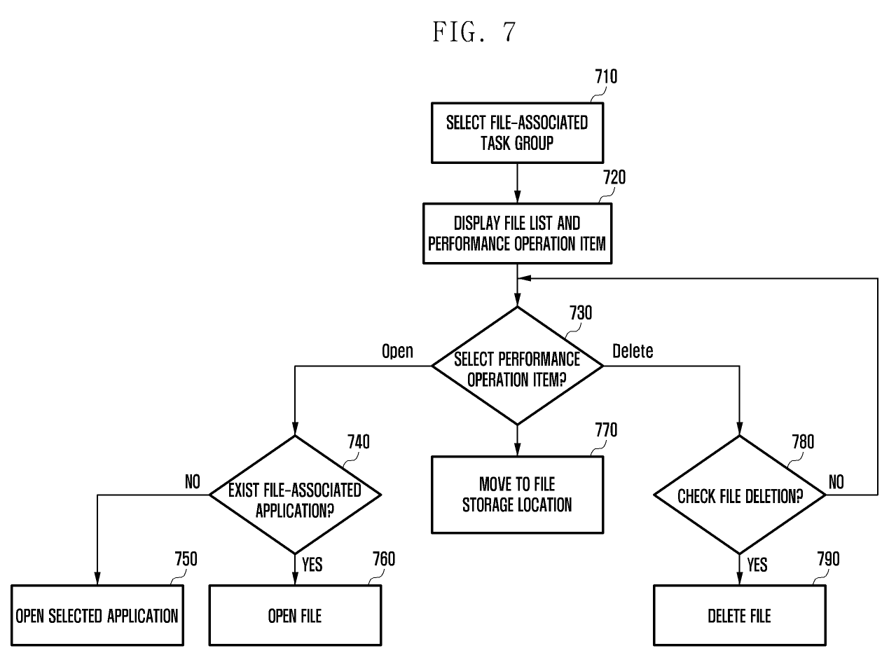

FIG. 7 is a flowchart illustrating an operation of a file-associated task according to various embodiments.

In the following embodiments, each operation may be performed sequentially, but is not necessarily performed sequentially. For example, an order of each operation may be changed, and at least two operations may be performed in parallel.

According to one embodiment, blocks 710 to 790 may be understood as being performed in a processor (e.g., the processor 120 in FIG. 2) of an electronic device (e.g., the electronic device 101 in FIG. 2).

With reference to FIG. 7, the electronic device 101 may select a file-associated task according to a user’s command (block 710). When the file-associated task is selected, the electronic device 101 may display information on a file and a performance operation item (block 720). For example, the electronic device 101 may display information on each file included in the file-associated task in a form of an icon, an image, and/or a text. Further, the electronic device 101 may display a performance operation item for each file. For example, the performance operation item may include open, go to, and/or delete items. The electronic device 101 may select the performance operation item according to a user’s command (block 730).

When an open item is selected (block 730-open), the electronic device 101 may determine whether an associated application of the selected file exists (block 740). For example, the associated application of the file may be an application designated to a type of the selected file. When the associated application of the file does not exist (block 740-NO), the electronic device 101 may display a screen for selecting an application. When an application is selected, the electronic device 101 may execute the selected application and may open the selected file (block 750). Alternatively, when the associated application of the file exists (block 740-YES), the electronic device 101 may execute the existing associated application of the file and may open the selected file (block 760).

Alternatively, according to a user’s selection, a go to item may be selected. When the go to item is selected (block 730-go to), the electronic device 101 may move to a location in which the selected file is stored (770). That is, the electronic device 101 may display a location (e.g., a folder) in which the file is stored.

Alternatively, according to a user’s selection, a delete item may be selected. When the delete item is selected (block 730-delete), the electronic device 101 may identify whether to delete the file (block 780). When deletion of the file is confirmed (block 780-YES), the electronic device 101 may delete the file (block 790). Alternatively, when deletion of the file is canceled (block 780-NO), the electronic device 101 may return to a screen displaying information on the file and the performance operation item.

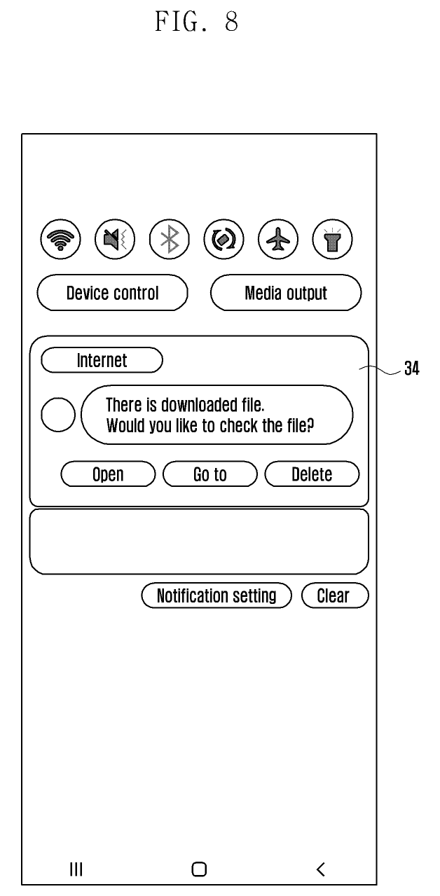

FIG. 8 is a diagram illustrating a notification message associated with a file-associated task according to various embodiments.

A user may perform a task for a downloaded (or shared) file. For example, the user may open a downloaded file, move to a file storage location, or delete the file. However, the user may download a file and may not perform any task. The electronic device 101 may output a notification message 34 when a task for a downloaded file is not performed for (or after) a preset time. For example, the preset time may be set to seven days. In this case, when any task is not performed for seven days after a file is downloaded, the electronic device 101 may output the notification message 34 indicating that there exists a non-performed file to the user.

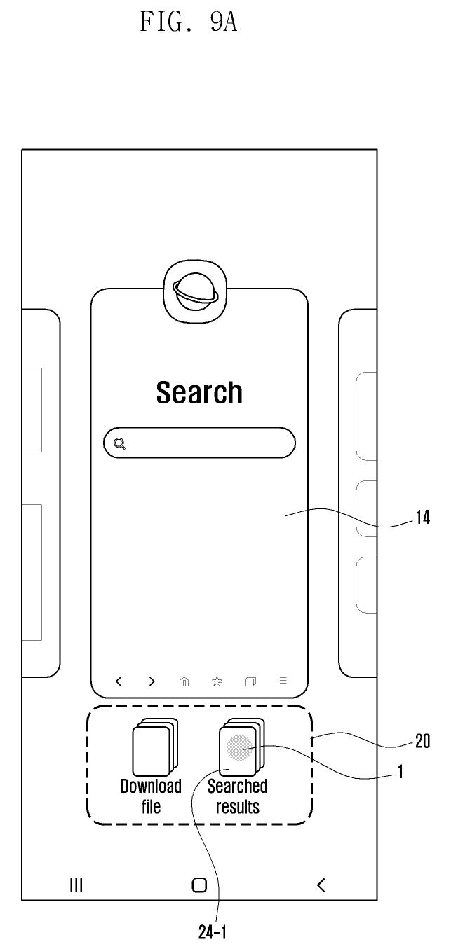

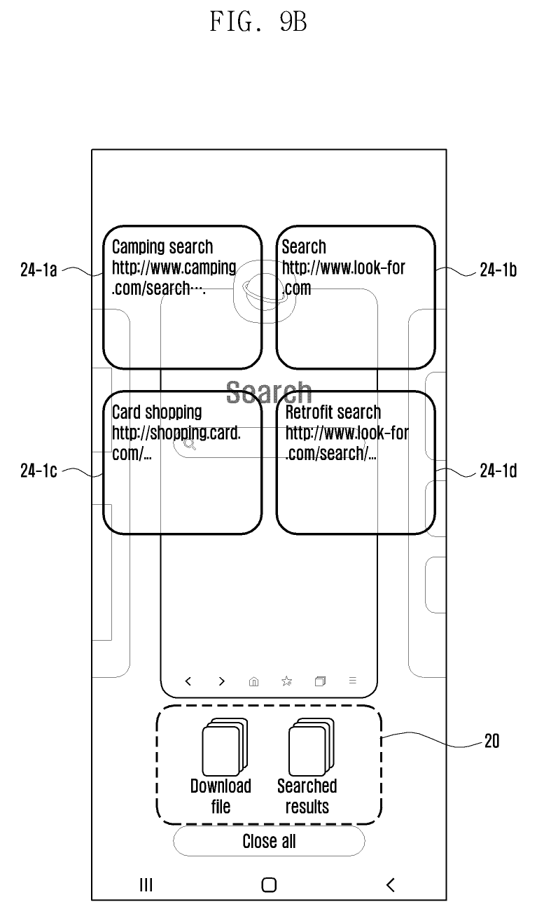

FIGS. 9A and 9B are diagrams illustrating a search task according to various embodiments.

With reference to FIG. 9A, a screen displaying a recently executed application is illustrated. For example, when an application most recently executed is a search application 14, the electronic device 101 may display the search application 14 as a main application. Alternatively, the electronic device 101 may switch the main application to the search application 14 by a user’s touch gesture. When a search task is performed in the search application 14, the task area 20 may include a search task 24-1. The search task 24-1 may include search information performed in the search application 14. The electronic device 101 may receive, as input (1), a command to select the search task 24-1.

With reference to FIG. 9B, a screen displaying search information included in the search task 24-1 is illustrated. When the selection of the search task 24-1 is input (1), the electronic device 101 may display the search information included in the search task 24-1. For example, the search information may be displayed as an icon, an image, and/or a text. The search information may be displayed transparently. Accordingly, in a background of a state in which the search information is displayed, the search application 14 as the main application may be viewed. Accordingly, in the state in which the search information is displayed, a user may easily identify an application in which the search is performed.

For example, when the search task 24-1 includes four pieces of search information, the electronic device 101 may display four search information 24-1a, 24-1b, 24-1c, and 24-1d. When one search information among the plurality of search information 24-1a, 24-1b, 24-1c, and 24-1d is selected, the electronic device 101 may execute the search application 14 and may display the last state (e.g., a state at the time of termination of the search task) of the selected search information.

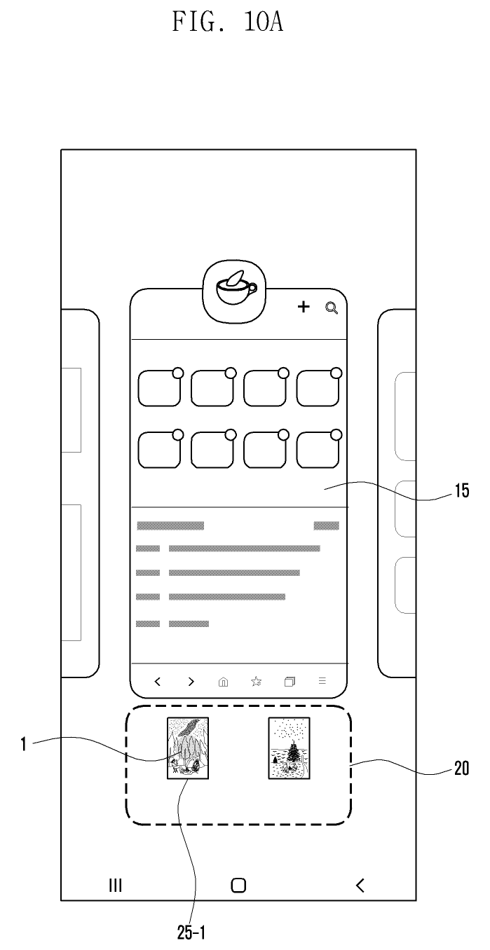

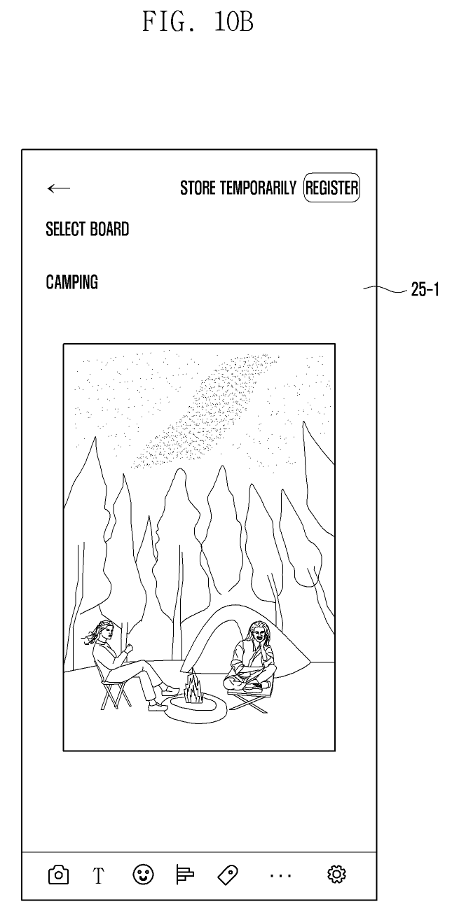

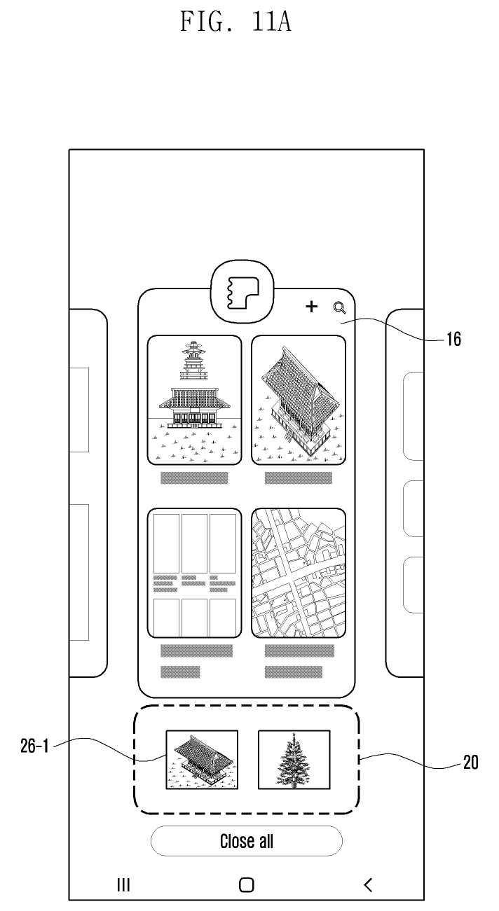

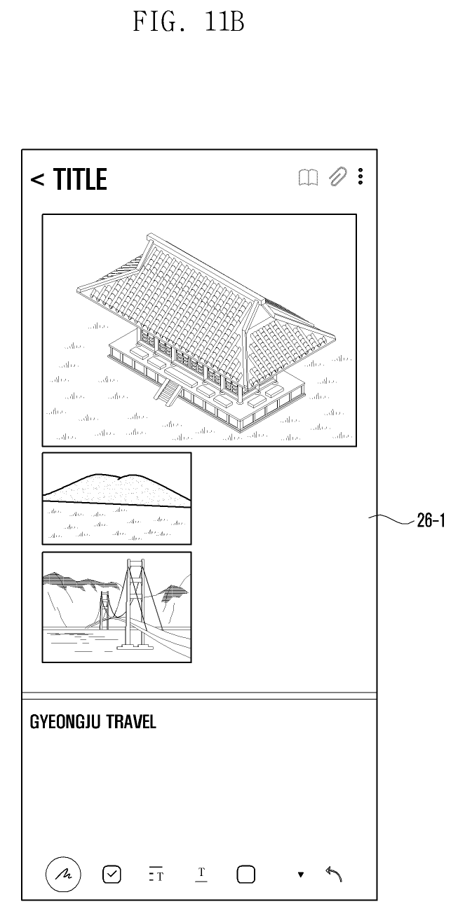

FIGS. 10A, 10B, 11A, and 11B are diagrams illustrating a temporary storing task according to various embodiments.

With reference to FIG. 10A, a screen displaying a recently executed application is illustrated. For example, an application most recently executed may be a community application 15. The electronic device 101 may display the community application 15 as a main application. Alternatively, the electronic device 101 may switch the main application to the community application 15 by a user’s touch gesture. The community application 15 is an application including a memo attribute, and may include a temporary storing task 25-1. For example, when an edit task in the community application 15 is not completed and is temporarily stored, a task area 20 corresponding to the community application 15 may include the temporary storing task 25-1. The temporary storing task 25-1 may include temporary storing information on an edit task being performed in the community application 15. The electronic device 101 may receive, as input (1), a command to select the temporary storing task 25-1.

With reference to FIG. 10B, a screen of the temporary storing task 25-1 is illustrated. When the selection of the temporary storing task 25-1 is input (1), the electronic device 101 may execute the community application 15 and may display the temporary storing task 25-1 based on information on the temporary storing task 25-1. The electronic device 101 may display the last state (e.g., a state at the time of termination of the temporary storing task) of the temporary storing task 25-1.

With reference to FIG. 11A, a screen displaying a recently executed application is illustrated. For example, an application most recently executed may be a memo application 16. The electronic device 101 may display the memo application 16 as a main application. Alternatively, the electronic device 101 may switch the main application to the memo application 16 by a user’s touch gesture. The memo application 16 is an application including a memo attribute, and may include a temporary storing task 26-1. When a writing task in the memo application 16 is not completed and is temporarily stored, the task area 20 may include the temporary storing task 26-1. The temporary storing task 26-1 may include temporary storing information on a writing task being performed in the memo application 16. The electronic device 101 may receive, as input, a command to select the temporary storing task 26-1.

With reference to FIG. 11B, a screen of the temporary storing task 26-1 is illustrated. When the temporary storing task 26-1 is selected, the electronic device 101 may execute the memo application 16 and may display the temporary storing task 26-1 based on information on the temporary storing task 26-1. The electronic device 101 may display the last state (e.g., a state at the time of termination of the temporary storing task) of the temporary storing task 26-1.

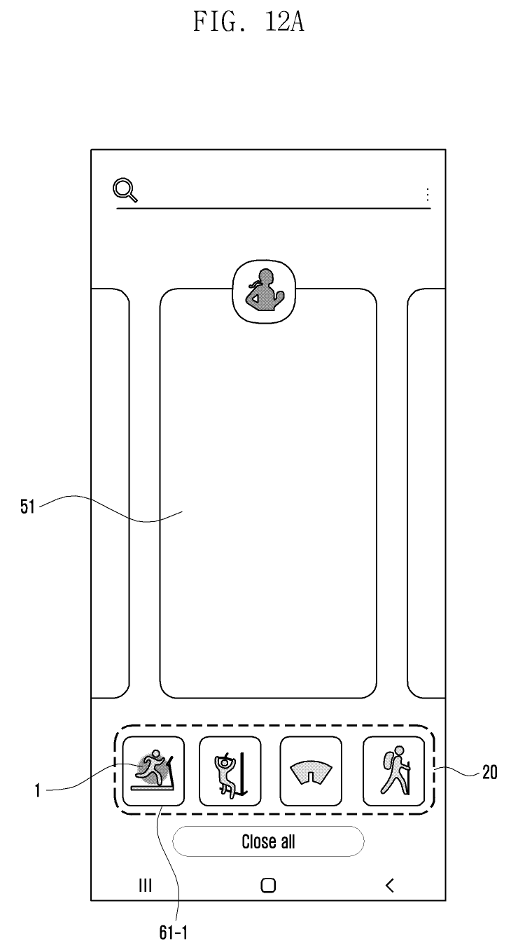

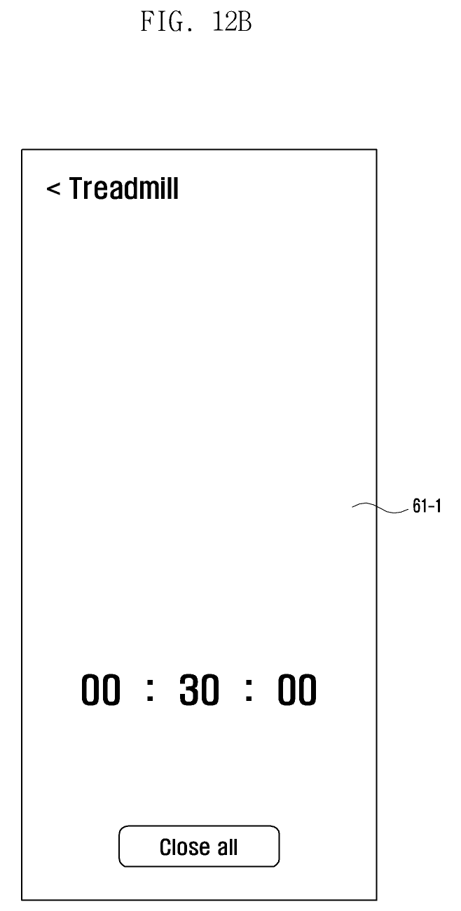

FIGS. 12A and 12B are diagrams illustrating a task associated with a measurement application according to various embodiments.

With reference to FIG. 12A, a screen displaying a recently executed application is illustrated. The most recently executed application may be the health application 51. The electronic device 101 may display the health application 51 as a main application. Alternatively, the electronic device 101 may switch the main application to the health application 51 by a user’s touch gesture. The health application 51 may perform various measurement tasks such as exercise time by type of exercise, number of times of exercises, weight, blood pressure, and/or body fat, etc. The measurement task may be a type of actionable task. A task area 20 corresponding to the health application 51 may include an actionable task 61-1 (e.g., a blood pressure measurement task) executed in the health application 51. The electronic device 101 may receive, as input (1), a command to select the actionable task 61-1.

With reference to FIG. 12B, a screen of the actionable task 61-1 is illustrated. When the actionable task 61-1 is selected, the electronic device 101 may execute the health application 51 and may display the actionable task 61-1 based on information on the actionable task 61-1. The electronic device 101 may display the last state (e.g., a state at the time of termination of the actionable task) of the actionable task 61-1. As one example, the actionable task 61-1 may be a treadmill actionable task, and a state at the time of termination of the treadmill actionable task may be a state set to 30 minutes. Accordingly, when the electronic device 101 performs the treadmill actionable task, the electronic device 101 may display the state set to 30 minutes.

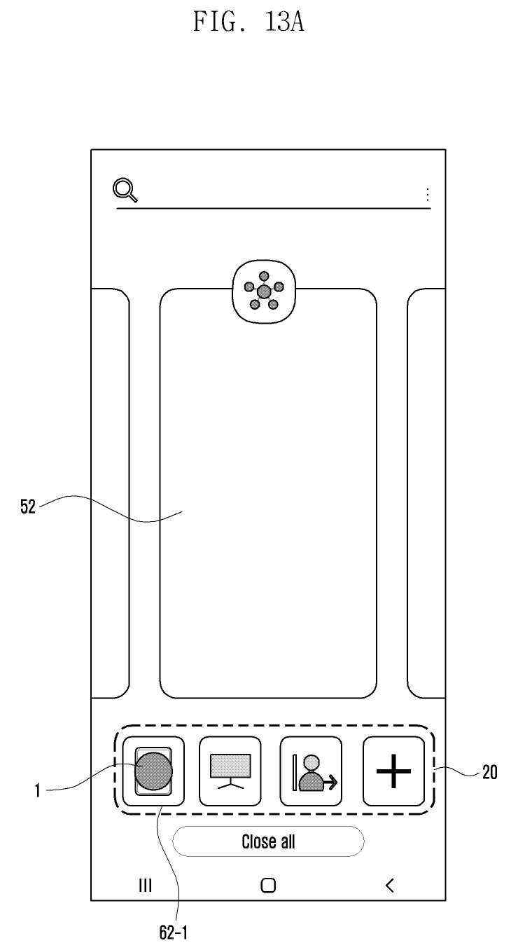

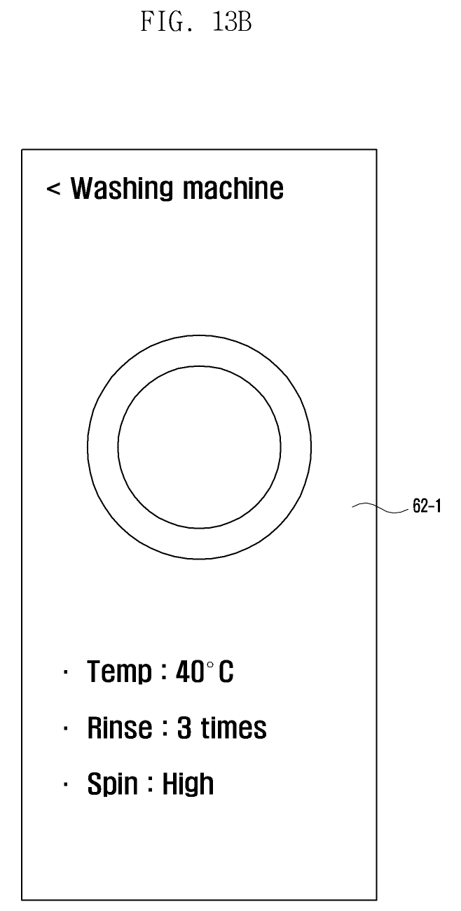

FIGS. 13A and 13B are diagrams illustrating a task associated with a control application according to various embodiments.

With reference to FIG. 13A, a screen displaying a recently executed application is illustrated. An application most recently executed may be an IoT application 52. The electronic device 101 may display the IoT application 52 as a main application. Alternatively, the electronic device 101 may switch the main application to the IoT application 52 by a user’s touch gesture. The IoT application 52 may perform a task of controlling various IoT devices. The control task may be a type of actionable task. A task area 20 corresponding to the IoT application 52 may include an actionable task 62-1 (e.g., an IoT lighting control task) executed in the IoT application 52. The electronic device 101 may receive, as input (1), a command to select the actionable task 62-1.

With reference to FIG. 13B, a screen of the actionable task 62-1 is illustrated. When the actionable task 62-1 is selected, the electronic device 101 may execute the IoT application 52 and may display the actionable task 62-1 based on information on the actionable task 62-1. The electronic device 101 may display a last state (e.g., a state at a time of termination of the actionable task) of the actionable task 62-1. As one example, the actionable task 62-1 may be a washing machine actionable task, and a state at the time of termination of the washing machine actionable task may be a state in which the temperature is set to 40 degrees, the rinsing is set to three times, and the spin intensity is set to high. Accordingly, when the electronic device 101 performs the washing machine actionable task, the electronic device 101 may display the state set to 40 degrees for temperature, three times for rinsing, and high for spin intensity, and may control the washing machine with a setting item.

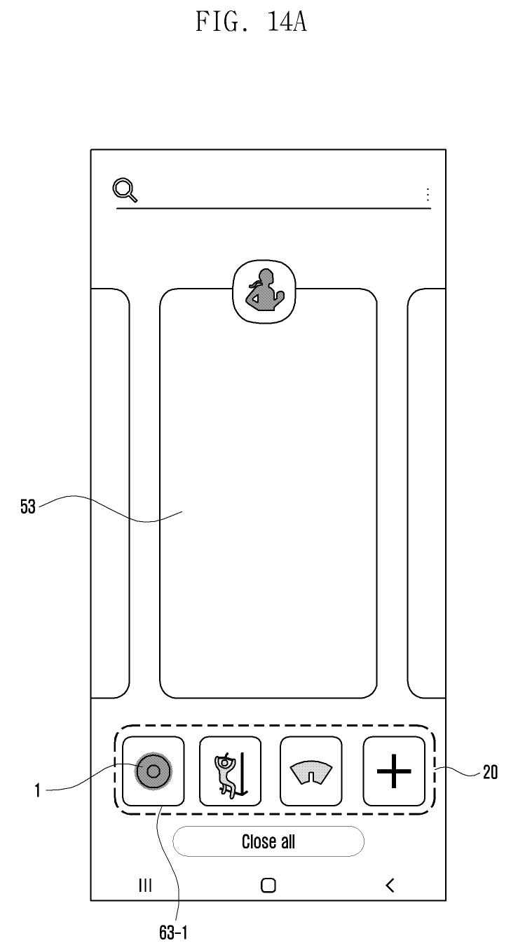

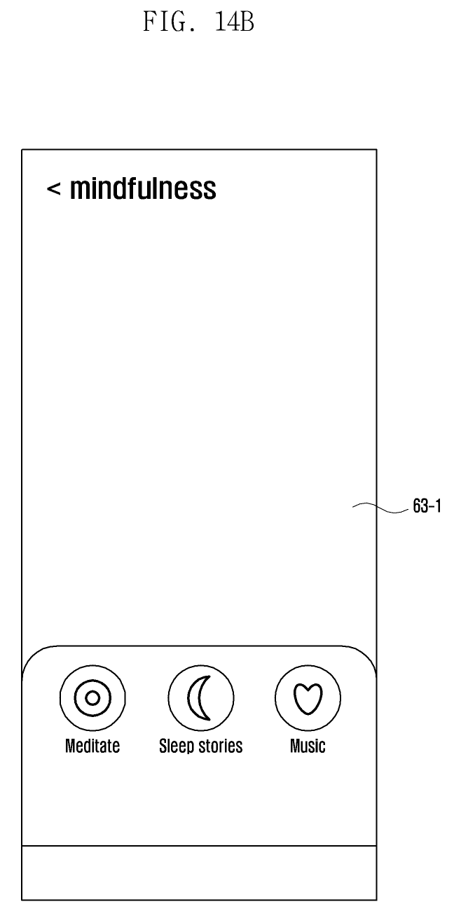

FIGS. 14A and 14B are diagrams illustrating a frequent-use task according to various embodiments.

With reference to FIG. 14A, a screen displaying a recently executed application is illustrated. An application most recently executed may be a measurement application or a control application. As one example, as illustrated in FIG. 14A, an application most recently executed may be a health application 53. The electronic device 101 may display the health application 53 as a main application. Alternatively, the electronic device 101 may switch the main application to the health application 53 by a user’s touch gesture. In this case, the task area 20 may include a frequent-use task 63-1. For example, the electronic device 101 may determine a number of times of performances of a task. Further, when the number of times of performances of the task is equal to or greater than a preset number of times, the electronic device 101 may generate a frequent-use task 63-1 and may allow the task performed equal to or greater than the preset number of times to be included. When the frequent-use task 63-1 is generated, the electronic device 101 may allow the frequent-use task 63-1 to be included in the task area. That is, the task area 20 may include a performed task and a frequent-use task. As one example, when a meditation task in the health application 53 is used equal to or greater than a preset number of times, the electronic device 101 may register (or generate) the meditation task as a frequent-use task and may display the meditation task in the task area 20.

The electronic device 101 may generate one frequent-use task, and may generate a plurality of frequent-use tasks. For example, when the preset number of times is ten times, the electronic device 101 may register as a frequent-use task a first task performed for the first ten times. Thereafter, a second task may be used eleven times. When the electronic device 101 is set to register one frequent-use task, the electronic device 101 may replace the frequent-use task from the first task to the second task. Alternatively, when the electronic device 101 is set to register a plurality of frequent-use tasks, when the second task is performed ten times, the electronic device 101 may register the second task as a frequent-use task separately from the first task. The electronic device 101 may receive, as input (1), a command to select the frequent-use task 63-1.

With reference to FIG. 14B, a screen of an actionable task registered as the frequent-use task 63-1 is illustrated. When a selection of the actionable task registered as the frequent-use task 63-1 is input (1), the electronic device 101 may execute the health application 53 and may display the actionable task based on information on the actionable task registered as the frequent-use task 63-1. The electronic device 101 may display the last state (e.g., a state at the time of termination of the actionable task) of the actionable task. As one example, the actionable task registered as the frequent-use task 63-1 may be a mindfulness task, and a state at the time of termination of the mindfulness task may be a state including items of meditation, sleep story, and music. Accordingly, when the electronic device 101 performs the mindfulness task, the electronic device 101 may display the state including the items of meditation, sleep story, and music.

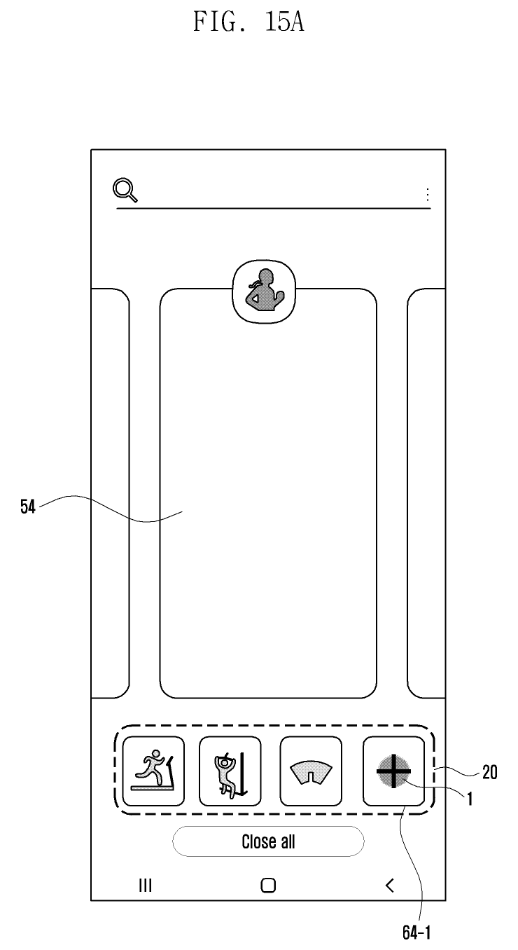

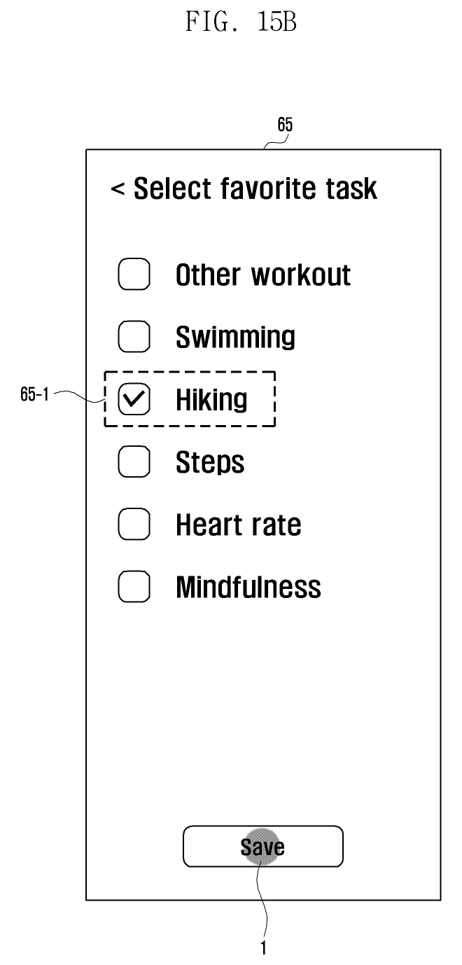

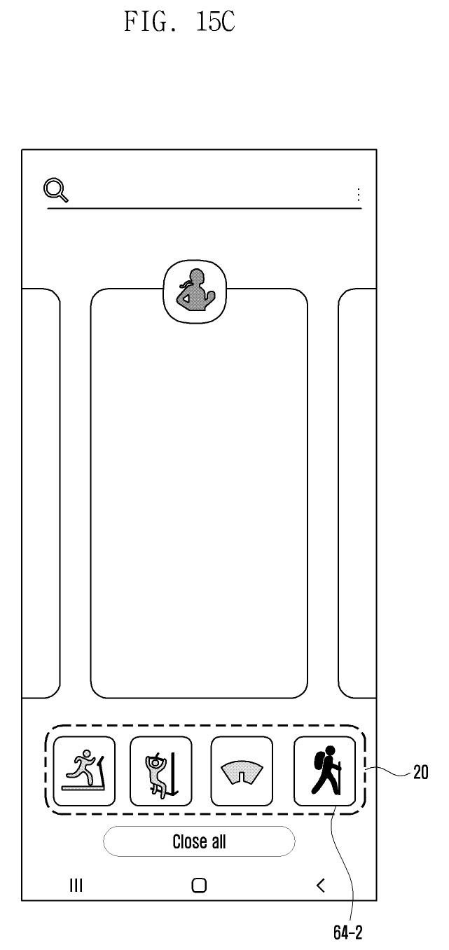

FIGS. 15A, 15B, and 15C are diagrams illustrating a user registration task according to various embodiments.

With reference to FIG. 15A, a screen displaying a recently executed application is illustrated. An application most recently executed may be a measurement application or a control application. As one example, as illustrated in FIG. 15A, an application most recently executed may be a health application 54. The electronic device 101 may display the health application 54 as a main application. Alternatively, the electronic device 101 may switch the main application to the health application 54 by a user’s touch gesture. In this case, the task area 20 may include a user registration item 64-1. The electronic device 101 may receive, as input (1), a command to select the user registration item 64-1.

With reference to FIG. 15B, a list 65 of tasks to be registered is illustrated. The list 65 of tasks to be registered may include tasks corresponding to a main application. For example, as illustrated in FIG. 15A, when the main application is a health application 54, the list 65 of tasks to be registered may include tasks associated with the health application 54. In addition, the electronic device 101 may sort the tasks based on a number of times of uses of the tasks and may display the tasks in the list 65 of tasks to be registered. As one example, the tasks associated with the health application 54 may include a heart rate task, a hiking task, a mindfulness task, a walking task, and a swimming task. Further, the number of times of uses of the heart rate task may be one, the number of times of uses of the hiking task may be four times, the number of times of uses of the mindfulness task may be zero, the number of times of uses of the walking task may be three times, and the number of times of uses of the swimming task may be six times. The electronic device 101 may sort and display the tasks in the order of the swimming task, the hiking task, the walking task, the heart rate task, and the mindfulness task based on the number of times of uses. The electronic device 101 may receive, as input (1), a command to select and store the hiking task 65-1.

With reference to FIG. 15C, a screen in which a user registration task 64-2 is displayed is illustrated. When the task is selected and stored, the electronic device 101 may generate the user registration task 64-2 and may allow the user registration task 64-2 to be included in the task area 20. That is, the task area may include the user registration task 64-2. As one example, when the registered task in the health application 54 is the hiking task, the electronic device 101 may display the hiking task.

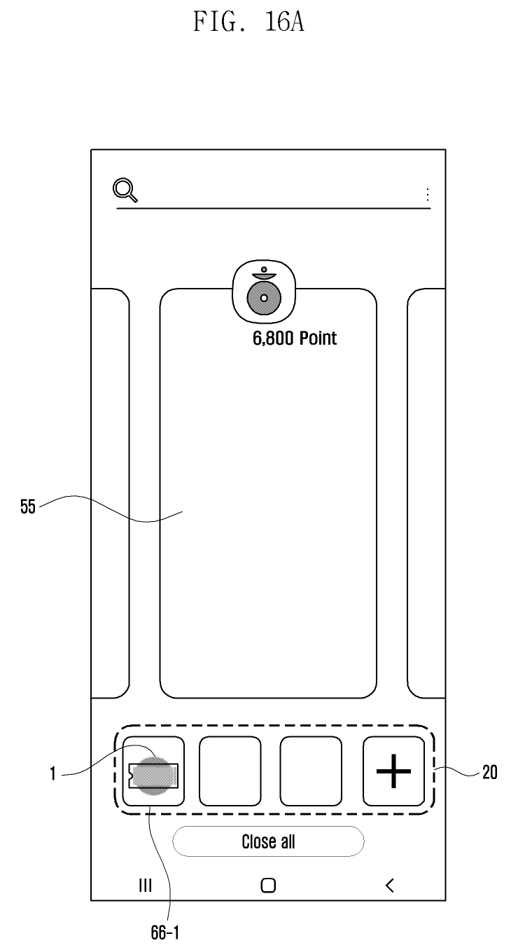

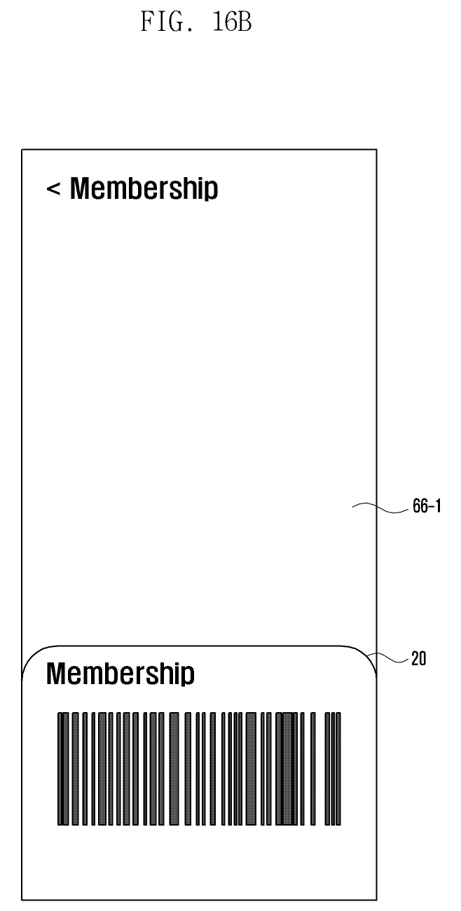

FIGS. 16A and 16B are diagrams illustrating an associated task according to various embodiments.

With reference to FIG. 16A, a screen displaying a recently executed application is illustrated. When an application most recently executed is a point earning application 55, the electronic device 101 may display the point earning application 55 as a main application. Alternatively, the electronic device 101 may switch the main application to the point earning application 55 by a user’s touch gesture. In this case, the task area 20 may include an associated task 66-1 (e.g., a routine task). For example, when a user purchases a product, the user may accumulate points through the point earning application 55 and may receive a discount through a membership application. When the user executes the point earning application and the membership application every time the user purchases a product, the electronic device 101 may identify an execution routine of a plurality of applications successively performed. Further, the electronic device 101 may relate the membership application with the point earning application 55. Further, the electronic device 101 may generate the associated task 66-1 in the task area 20. When the point earning application 55 is displayed in an application area 10 of a recently executed application screen, the electronic device 101 may display the associated task 66-1 in the task area. Alternatively, the electronic device 101 may relate the point earning application with the membership application. When the membership application is displayed as a recently executed application, the electronic device 101 may display the associated task 66-1 (e.g., the point earning application) in the task area 20. The electronic device 101 may receive, as input (1), a command to select the associated task 66-1.

With reference to FIG. 16B, a screen of an associated task 66-1 is illustrated. When the associated task 66-1 displayed in the task area 20 is selected, the electronic device 101 may execute an associated application and may display the associated task 66-1. For example, when the associated task 66-1, which is a membership application, displayed in the task area 20 of the point earning application is selected, the electronic device 101 may execute the membership application and may display a membership identification information screen, which is the associated task 66-1.

Alternatively, the electronic device 101 may allow a user to register the associated task 66-1. For example, when the point earning application 55 is displayed, the electronic device 101 may display a task registration item in the task area 20. Further, when the task registration item is selected, the electronic device 101 may display the membership application. When the membership application is selected, the electronic device 101 may generate the membership application as the associated task 66-1 and may display the membership application in the task area 20.

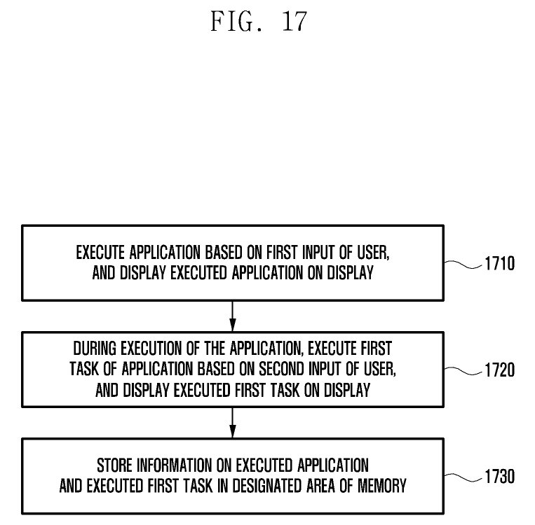

FIG. 17 is a flowchart illustrating a method of executing an application according to various embodiments.

In the following embodiments, each operation may be performed sequentially, but is not necessarily performed sequentially. For example, an order of each operation may be changed, and at least two operations may be performed in parallel.

According to one embodiment, blocks 1710 to 1730 may be understood as being performed in a processor (e.g., the processor 120 in FIG. 2) of an electronic device (e.g., the electronic device 101 in FIG. 2).

With reference to FIG. 17, the electronic device 101 may execute an application based on a user’s first input and may display the executed application on the display 160 (block 1710). For example, the application may include a messenger application (e.g., a chatting application, an SMS application), a search application, an application including a memo attribute (e.g., a community application, a memo application), a measurement application (e.g., a health application), and/or a control application (e.g., an IoT application), etc.

While the application is executed, the electronic device 101 may execute a first task of the application based on a user’s second input and may display the executed first task on the display 160 (block 1720). For example, when the executed application is a messenger application, a task to be performed may be a file-associated task and/or a messenger task. When the executed application is a search application, a task to be performed may be a file-associated task and/or a search task. When the executed application is an application including a memo attribute, a task to be performed may be an edit task and/or a temporary storing task. When the executed application is a measurement application or a control application, a task to be performed may be an actionable task. When the executed application is a membership application or a point-associated application, a task to be performed may be a point-associated task.

The electronic device 101 may store information on the executed application and the executed first task in a designated area of the memory 130 (block 1730). The designated area of the memory may be a storage area designated in the executed application. For example, the information on the task may include link information to be displayed on the display 160, a type of the task, a file name, last perform information, an image, a text, and/or a setting item.

When the electronic device 101 receives, as input, a command to display a recently executed application, the electronic device 101 may identify the recently executed application. Further, the electronic device 101 may identify a task executed in the identified application. The electronic device 101 may display, on the display 160, information on a first application among the identified applications and information on a task executed in the first application. When a recently executed application is displayed, the electronic device 101 may display a task area 20 together with the application. The task area may include a task corresponding to the identified application based on information on the task executed in the identified application. For example, when the first application is a messenger application, the electronic device 101 may display, on the display 160, information on a file-associated task and/or a messenger task executed in the messenger application. When the first application is a search application, the electronic device 101 may display, on the display 160, information on a file-associated task and/or a search task executed in the search application. When the first application is an application including a memo attribute, the electronic device 101 may display, on the display 160, information on a temporary storing task of a memo executed in the application including the memo attribute. When the first application is a measurement application or a control application, the electronic device 101 may display, on the display 160, information on an actionable task executed in the measurement application or the control application.

When one task among the tasks displayed in the task area 20 is selected, the electronic device 101 may execute an application in which the selected task has been performed and may display information on the selected task. For example, when the recently executed application is a messenger application and a messenger task is selected, the electronic device 101 may execute the messenger application and may display the messenger task on the display 160 based on link information on the messenger task. When the recently executed application is a search application and a search task is selected, the electronic device 101 may execute the search application and may display the search task on the display 160 based on link information on the search task. When the recently executed application is a messenger application or a search application and a file-associated task is selected, the electronic device 101 may display, on the display 160, information on a file included in the file-associated task and a performance operation item. For example, the performance operation item may include an open item, a go to item, and/or a delete item. When the recently executed application is an application including a memo attribute and a temporary storing task is selected, the electronic device 101 may execute the application including the memo attribute and may display the temporary storing task on the display 160 based on link information on the temporary storing task. Alternatively, when the recently executed application is a measurement application or the control application and an actionable task is selected, the electronic device 101 may execute the measurement application or the control application and may display the actionable task on the display 160 based on link information on the actionable task. The electronic device 101 may display a final state of an application at a termination point in time (or a final state of termination point in time of the task) based on information on the performed task.

In addition, the electronic device 101 may generate, as a frequent-use task, a task used equal to or greater than a preset number of times or may generate, as a user registration task, a task registered by a user. The electronic device 101 may display, in a task area 20, a generated frequent-use task and/or a user registration task.

As one example, a method of executing and storing an application may include executing an application based on a user’s first input and displaying the executed application on the display 160. The method of executing and storing the application may include, while the application is executed, executing a first task of the application based on a user’s second input and displaying the executed first task on the display 160. The method of executing and storing the application may include storing information on the executed application and the executed first task in a designated area of the memory 130.

As one example, the information on the executed first task may include link information to be displayed on the display 160.

As one example, the designated area of the memory 130 may be a storage area designated in the application.

As one example, the method of executing and storing the application may include, when receiving, as input, a command to display at least one recently executed application, identifying the at least one recently executed application and identifying at least one task executed in the identified at least one application. The method of executing and storing the application may include displaying, on the display 160, information on a first application among the identified at least one application and information on at least one task executed in the first application.

As one example, a method of displaying the application may include receiving, as input, a user input to display at least one recently executed application. The method of displaying the application may display information on an application including the at least one recently executed application based on the user input. The information on the displayed application may include a main area indicating a first application among the at least one application and a task area indicating information on at least one task executed in the first application.

As one example, an operation of displaying the information on the application may include, when the first application is a messenger application, displaying, in the task area, information on at least one task among a file-associated task and a messenger task executed in the messenger application.

As one example, the method of displaying the application may include, when the messenger task is selected, executing the messenger application and displaying the messenger task on the display 160 based on link information on the messenger task.

As one example, the method of displaying the application may include, when the file-associated task is selected, displaying, on the display 160, information on at least one file included in the file-associated task and a performance operation item.

As one example, the performance operation item may include at least one among an open item, a go to item, and a delete item.

As one example, the method of displaying the application may include, when there is no perform operation for the at least one file during a preset time, displaying a message associated with the non-performance of the file.

As one example, an operation of displaying the information on the application may include, when the first application is a search application, displaying, in the task area, information on at least one task among a file-associated task and a search task executed in the search application.

As one example, the method of displaying the application may include, when the search task is selected, executing the search application and displaying the search task on the display 160 based on link information on the search task.

As one example, an operation of displaying the information on the application may include, when the first application is an application including a memo attribute, displaying, in the task area, information on a temporary storing task of a memo executed in the application including the memo attribute.

As one example, the method of displaying the application may include, when the temporary storing task is selected, executing the application including the memo attribute and displaying the temporary storing task on the display 160 based on link information on the temporary storing task.

As one example, an operation of displaying the information on the application may include, when the first application is a measurement application or the control application, displaying, in the task area, information on an actionable task executed in the measurement application or the control application.

As one example, the method of displaying the application may include registering, as a frequent-use task, an actionable task used equal to or greater than a preset number of times in the measurement application or the control application. The operation of displaying the information on the application may include displaying, in the task area, information on the registered frequent-use task together with the measurement application or the control application.

As one example, the method of displaying the application may include, when a task registration item is selected, sorting and displaying at least one actionable task associated with the measurement application or the control application based on a number of times of uses.

As one example, the method of displaying the application may include, when a task registration item is selected, sequentially receiving, as input, at least one second application to be successively performed with the first application. The method of displaying the application may register the input at least one second application as an associated task with the first application. The operation of displaying the information on the application may include displaying, in the task area, information on the registered associated task together with the first application.

As one example, the method of displaying the application may include identifying an execution routine of at least one second application successively performed with the first application. The method of displaying the application may register the identified at least one second application as an associated task with the first application. The operation of displaying the information of the application may include displaying, in the task area, information of the registered associated task together with the first application.

As one example, the electronic device 101 may include a display 160, a memory 130 storing instructions to be executed, and at least one processor 120 accessing the memory 130 and executing the instructions. The at least one processor 120 may, when receiving, as input, a command to display at least one recently executed application, identify the at least one recently executed application. The at least one processor 120 may identify at least one task executed in the identified at least one application. The at least one processor 120 may display, in a main area of the display 160, the first application among the identified at least one application, and may display, in a task area of the display 160, information on at least one task executed in the first application.

As one example, the information on the at least one task may include link information to be displayed on the display 160.

As one example, the link information may be stored in an area of the memory 130 designated in the application.

As one example, the at least one processor 120 may, when the first application is a messenger application, display, in the task area, information on at least one task among a file-associated task and a messenger task executed in the messenger application.

As one example, the at least one processor 120 may, when the messenger task is selected, execute the messenger application and display the messenger task on the display 160 based on link information on the messenger task.

As one example, the at least one processor 120 may, when the file-associated task is selected, display, on the display 160, information on at least one file included in the file-associated task and a performance operation item.

As one example, the at least one processor 120 may, when there is no perform operation for the at least one file during a preset time, display, on the display 160, a message associated with the non-performance of the file.

As one example, the at least one processor 120 may, when the first application is a search application, display, in the task area, information on at least one task among a file-associated task and a search task executed in the search application.

As one example, the at least one processor 120 may, when the search task is selected, execute the search application and display the search task on the display 160 based on link information on the search task.

As one example, the at least one processor 120 may, when the first application is an application including a memo attribute, display, in the task area, information on a temporary storing task of a memo executed in the application including the memo attribute.

As one example, the at least one processor 120 may, when the temporary storing task is selected, execute the application including the memo attribute and display the temporary storing task on the display 160 based on link information on the temporary storing task.

As one example, the at least one processor 120 may, when the first application is a measurement application or the control application, display, in the task area, information on an actionable task executed in the measurement application or the control application.

As one example, the at least one processor 120 may register, as a frequent-use task, an actionable task used equal to or greater than a preset number of times in the measurement application or the control application, and may display, in the task area, information on the registered frequent-use task together with the measurement application or the control application.

As one example, the at least one processor 120 may identify an execution routine of at least one second application successively performed with the first application, register the identified at least one second application as an associated task with the first application, and display, in the task area, information on the registered associated task together with the first application.

It should be appreciated that various examples of the disclosure and the terms used therein are not intended to limit the technological features set forth herein to particular examples and include various changes, equivalents, or replacements for a corresponding example. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it denotes that the element may be coupled with the other element directly (e.g., wiredly), wirelessly, or via a third element.

As used in connection with various examples of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an example, the module may be implemented in a form of an application-specific integrated circuit (ASIC).

Various examples as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an example, a method according to various examples of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities, and some of the multiple entities may be separately disposed in different components. According to various examples, one or more of the above-described components may be omitted, or one or more other components may be added. Alternatively or additionally, a plurality of components (e.g., modules or programs) may be integrated into a single component. In such a case, according to various examples, the integrated component may still perform one or more functions of each of the plurality of components in the same or similar manner as they are performed by a corresponding one of the plurality of components before the integration. According to various examples, operations performed by the module, the program, or another component may be carried out sequentially, in parallel, repeatedly, or heuristically, or one or more of the operations may be executed in a different order or omitted, or one or more other operations may be added.

The effects of the present document are not limited to the effects mentioned above, and other effects not mentioned may be clearly understood by those skilled in the art from the above description.

What is claimed is:

1. A method of displaying an application information on an electronic device, comprising:
detecting a user input for requesting display of at least one recently executed application; and
in response to the user input, generating a user interface including:
a primary display region configured to present a most recently executed application from the at least one recently executed application; and
a secondary display region configured to display task information associated with the most recently executed application,
wherein the task information includes at least one executable task item corresponding to the most recently executed application.

2. The method of claim 1, further comprising:
when the most recently executed application is a messenger application, displaying, in the secondary display region, the task information on the at least one task among a file-associated task and a messenger task executed in the messenger application.

3. The method of claim 2, further comprising:
executing the messenger application and displaying the messenger task on the display based on link information on the messenger task when the messenger task is selected.

4. The method of claim 2, further comprising:
displaying, on the display, the task information on at least one file included in the file-associated task and a performance operation item when the file-associated task is selected.

5. The method of claim 4, wherein the performance operation item comprises at least one of an open item, a go to item, or a delete item.

6. The method of claim 4, further comprising:
displaying a message associated with a non-performance of the at least one file when there is no performance operation for the at least one file during a preset time.

7. The method of claim 1, further comprising:
when the most recently executed application is a search application, displaying, in the secondary display region, the task information on the at least one task among a file-associated task and a search task executed in the search application.

8. The method of claim 7, further comprising:
executing the search application and displaying the search task on the display based on link information on the search task when the search task is selected.

9. The method of claim 1, further comprising:
when the most recently executed application is a memo application including a memo attribute, displaying, in the secondary display region, the task information on a temporary storing task of a memo executed in the memo application including the memo attribute.

10. The method of claim 9, further comprising:
executing the memo application including the memo attribute and displaying the temporary storing task on the display based on link information on the temporary storing task when the temporary storing task is selected.

11. The method of claim 1, further comprising:
when the most recently executed application is a measurement application or a control application, displaying, in the secondary display region, the task information on an actionable task executed in the measurement application or the control application.

12. The method of claim 11, further comprising:
registering, as a frequent-use task, the actionable task used equal to or greater than a preset number of times in the measurement application or the control application; and
displaying, in the secondary display region, the task information on the frequent-use task together with the measurement application or the control application.

13. The method of claim 11, further comprising:
sorting and displaying, based on a number of times of uses, at least one actionable task associated with the measurement application or the control application when a task registration item is selected.

14. The method of claim 1, further comprising:
sequentially receiving, as input, at least one application successively performed with the most recently executed application when a task registration item is selected;
registering the at least one application as an associated task with the most recently executed application; and
displaying, in the secondary display region, the task information on the associated task together with the most recently executed application.

15. An electronic device, comprising:
a display;
at least one processor; and
memory storing instructions that, when executed by the at least one processor individually or collectively, cause the electronic device to:
detect a user input for requesting display of at least one recently executed application, generate, in response to the user input, a user interface including:
a primary display region of the display configured to present a most recently executed application from the at least one recently executed application; and
a secondary display region of the display configured to display task information associated with the most recently executed application,
wherein the task information includes at least one executable task item corresponding to the most recently executed application.

16. The electronic device of claim 15, wherein the instructions cause the electronic device to, when the most recently executed application is a messenger application, display, in the secondary display region, the task information on the at least one task among a file-associated task and a messenger task executed in the messenger application.

17. The electronic device of claim 16, wherein the instructions cause the electronic device to execute the messenger application and display the messenger task on the display based on link information on the messenger task when the messenger task is selected.

18. The electronic device of claim 16, wherein the instructions cause the electronic device to display, on the display, the task information on at least one file included in the file-associated task and a performance operation item when the file-associated task is selected.

19. The electronic device of claim 18, wherein the performance operation item comprises at least one of an open item, a go to item, or a delete item.

20. The electronic device of claim 18, wherein the instructions cause the electronic device to display a message associated with a non-performance of the at least one file when there is no performance operation for the at least one file during a preset time.
